(19) United States
(12) Patent Application Publication
(10) Pub. No.: US 2024/0168183 A1
(43) Pub. Date: May 23, 2024

(54) RADIATION IMAGING APPARATUS

(71) Applicant: CANON KABUSHIKI KAISHA, Tokyo (JP)

(72) Inventors: RYO EZURE, Tokyo (JP); KENJI YAMAGUCHI, Kanagawa (JP)

(21) Appl. No.: 18/512,945

(22) Filed: Nov. 17, 2023

(30) Foreign Application Priority Data
Nov. 21, 2022 (JP) 2022-185711
Feb. 24, 2023 (JP) 2023-027291
Aug. 14, 2023 (JP) 2023-132093

(51) Int. Cl. G01T 1/208; G01T 1/29

(52) U.S. Cl. CPC G01T 1/208; G01T 1/2985

(57) ABSTRACT

A radiation imaging apparatus includes a radiation detection unit including a scintillator for converting radiation into light and a photoelectric conversion element for converting light into electric charge and configured to generate an image, an acquisition unit configured to acquire a first image generated by the radiation detection unit in a radiation irradiated state and, after that, acquire a second image generated by the radiation detection unit in a radiation non-irradiated state, and an estimation unit configured to estimate presence or absence of bright burn in the scintillator based on the second image.

### BACKGROUND OF THE DISCLOSURE

### Field of the Disclosure

Aspects of the present disclosure generally relate to a radiation imaging apparatus, a radiation imaging system, a control method for a radiation imaging apparatus, and a storage medium.

### Description of the Related Art

As an imaging apparatus for use in medical imaging diagnosis or non-destructive inspection using X-rays, a radiation imaging apparatus using a scintillator for converting X-rays into light and a flat panel detector (hereinafter abbreviated as “FPD”) formed from a semiconductor material is in widespread use. For example, in the case of non-destructive inspection, such a radiation imaging apparatus is able to be used to inspect an internal flaw or superficial flaw or a deterioration status without destroying a thing such as a printed circuit board or a pipe.

However, with respect to a thick subject such as a pipe, it is necessary to radiate a large quantity of X-rays onto the scintillator. In the scintillator, a phenomenon in which the sensitivity characteristic thereof varies in response to being irradiated with radiation may arise, and such a phenomenon is also called “bright burn”. Since this phenomenon causes an artifact or a subject's image lag to occur in an image obtained by the FPD and it takes time for the image to become normal again, there is known a correction method for removing bright burn.

The correction method for removing bright burn includes a technique which performs white image capturing with a subject excluded therefrom (hereinafter referred to as “gain calibration”) to update gain correction data and then, at the time of image capturing, performs gain correction with the updated gain correction data.

On the other hand, the image lag phenomenon also includes afterglow which occurs due to the fact that, even when radiation of X-rays is stopped, the luminescence of a scintillator does not cease and a phenomenon which occurs due to, for example, remaining charge transfer of an imaging element.

These phenomena are called “fixed pattern noise (FPN) image lag”, and, as a countermeasure for such FPN image lag, the above-mentioned gain calibration also serves as an effective countermeasure.

However, the gain calibration itself is a time-consuming operation, and, therefore, there is a desire to reduce performing the gain calibration to the minimum necessary.

Japanese Patent No. 4,468,083 discusses a technique which, as a FPN image lag countermeasure, determines the occurrence of an FPN image lag based on an X-ray non-irradiated image (hereinafter referred to as an “FPN image”) acquired at the time of preliminarily performing the gain calibration and an FPN image acquired immediately before image capturing of a subject and implements a countermeasure therefor.

Japanese Patent Application Laid-Open No. 2003-185752 discusses a method which performs correction using an image the parameters for which have been calculated based on a current captured bright burn image, the previous bright burn correction image, and a bright burn information image therefor.

If it is intended to determine the presence or absence of bright burn based on an X-ray non-irradiated image, the trouble of, for example, moving a subject after a set of imaging processing ends, radiating X-rays once again to acquire an image, and determining the presence or absence of bright burn based on the acquired image occurs. This leads to a decrease in throughput, and, in the case of, for example, piping inspection, the operation of moving a subject can be human work and, therefore, results in forcing the operator to spend surplus time and effort.

### SUMMARY OF THE DISCLOSURE

Aspects of the present disclosure are generally directed to enabling estimating the presence or absence of bright burn in a scintillator.

According to an aspect of the present disclosure, a radiation imaging apparatus includes a radiation detection unit including a scintillator for converting radiation into light and a photoelectric conversion element for converting light into electric charge and configured to generate an image, an acquisition unit configured to acquire a first image generated by the radiation detection unit in a radiation irradiated state and, after that, acquire a second image generated by the radiation detection unit in a radiation non-irradiated state, and an estimation unit configured to estimate presence or absence of bright burn in the scintillator based on the second image.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of a radiation imaging system according to a first exemplary embodiment.

FIG. 2 is a diagram illustrating a configuration example of a radiation inspection system for non-destructive inspection.

FIG. 3 is a flowchart illustrating a control method for the radiation imaging system.

FIG. 4 is a diagram illustrating an example of a fixed pattern noise (FPN) image obtained immediately after image capturing at the time of occurrence of bright burn.

FIG. 5 is a diagram illustrating an example of an in-plane pixel distribution in the X-axis direction.

FIG. 6 is a diagram illustrating a configuration example of a radiation imaging system according to a third exemplary embodiment.

FIG. 7 is a diagram illustrating a hardware configuration example of a control unit included in a radiation imaging apparatus.

FIG. 8 is a diagram illustrating a configuration example of an inspection apparatus.

FIG. 9A is a flowchart illustrating an example of processing for updating and switching of gain correction data.

FIG. 9B is a flowchart illustrating an example of processing for updating and switching of gain correction data.

FIG. 9C is a flowchart illustrating an example of processing for updating and switching of gain correction data.

FIG. 9D is a flowchart illustrating an example of processing for updating and switching of gain correction data.

### DESCRIPTION OF THE EMBODIMENTS

Various exemplary embodiments, features, and aspects of the present disclosure will be described in detail below with reference to the drawings. Furthermore, exemplary embodiments described below are not intended to limit the claims, and not all of the combinations of features described in each exemplary embodiment are necessarily essential for the solutions. Moreover, while, in the exemplary embodiments described below, it is favorable that X-ray is used as radiation, the exemplary embodiments are not limited to this, and, for example, other types of radiation, such as alpha ray, beta ray, and gamma ray, can be applied as radiation. The radiation is not limited to X-ray, and, for example, alpha ray, beta ray, gamma ray, particle ray, and cosmic ray are assumed to be also included in the radiation.

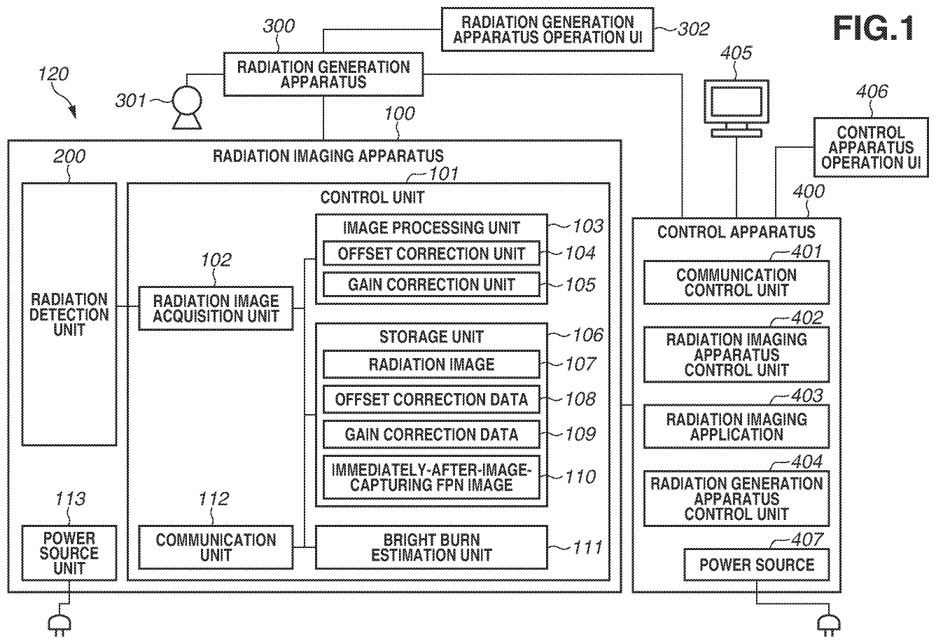

FIG. 1 is a diagram illustrating a configuration example of a radiation imaging system 120 according to a first exemplary embodiment. The radiation imaging system 120 includes a radiation imaging apparatus 100, a radiation source 301, a radiation generation apparatus 300, a radiation generation apparatus operation user interface (UI) 302, a display unit 405, a control apparatus operation UI 406, and a control apparatus 400.

The radiation source 301 radiates radiation. The radiation generation apparatus 300 controls the radiation source 301. The control apparatus 400 controls the radiation imaging apparatus 100 and the radiation generation apparatus 300 and includes a radiation imaging application 403, which is capable of, for example, collecting and displaying a radiation image transmitted from the radiation imaging apparatus 100.

The radiation imaging apparatus 100 includes a radiation detection unit 200, a control unit 101, and a power source unit 113. The radiation detection unit 200 detects radiation to generate image data. The control unit 101 controls image capturing and communication. The radiation detection unit 200 includes imaging elements and scintillators (phosphors) two-dimensionally distributed. The scintillator converts radiation falling on the radiation detection unit 200 into light. The imaging element includes a photoelectric conversion element which converts light obtained by conversion performed by the scintillator into electric charge, and thus generates two-dimensional radiation image data. The radiation detection unit 200 is a flat panel detector (FPD). Here, as an example, the scintillator is assumed to produce luminescence in proportion to the intensity of radiation falling on the radiation detection unit 200, and the imaging element is assumed to output a high pixel value in proportion to the intensity of luminescence of the scintillator.

The control unit 101 includes a radiation image acquisition unit 102, an image processing unit 103, a storage unit 106, a bright burn estimation unit 111, and a communication unit 112. The radiation image acquisition unit 102 acquires a radiation image from the radiation detection unit 200.

The radiation image acquisition unit 102 reads out electric charge from the respective imaging elements of the radiation detection unit 200 and completes acquisition of a radiation image when reading-out of electric charge from all of the imaging elements is finished. Moreover, after completion of the acquisition of a radiation image, the radiation image acquisition unit 102 performs a resetting operation for discarding, after reading, electric charge accumulated in the respective imaging elements of the radiation detection unit 200. The radiation image acquisition unit 102 causes a radiation image 107 acquired from the radiation detection unit 200 to be stored in the storage unit 106.

The image processing unit 103 includes an offset correction unit 104, which performs offset correction on the radiation image 107 stored in the storage unit 106, and a gain correction unit 105, which performs gain correction on the radiation image 107 stored in the storage unit 106. However, the image processing unit 103 can be configured to further include a correction unit which performs correction processing other than these corrections. Moreover, the offset correction unit 104 can be configured to perform generation processing for offset correction data 108. Moreover, the gain correction unit 105 can be configured to perform generation processing for gain correction data 109.

The storage unit 106 stores the radiation image 107, which has been acquired by the radiation image acquisition unit 102, and the offset correction data 108, which is used to perform offset correction on the radiation image 107.

Here, the offset correction data 108 is assumed to be an image preliminarily generated prior to execution of image capturing. Furthermore, an image acquired in a radiation non-irradiated state by the radiation image acquisition unit 102 in radiation images for the respective frames can be assumed to be the offset correction data 108. Moreover, the offset correction data 108 is not always one piece of data, and, for example, can be stored in each image size or each accumulation time of radiation in performing image capturing.

Additionally, the storage unit 106 stores gain correction data 109 preliminarily generated by the gain correction unit 105. Furthermore, the gain correction data 109 is not always one piece of data, and, for example, can be stored for each image size in performing image capturing. Moreover, the storage unit 106 further stores an immediately-after-image-capturing FPN image 110, which is an image captured by the radiation image acquisition unit 102 in a radiation non-irradiated state immediately after radiation imaging. The term “FPN” is an abbreviation for fixed pattern noise.

The bright burn estimation unit 111 estimates whether bright burn has occurred in scintillators by immediately preceding radiation imaging, based on the immediately-after-image-capturing FPN image 110 acquired immediately after radiation imaging. In the scintillator, a phenomenon in which the sensitivity characteristic thereof varies in response to being irradiated with radiation or a phenomenon in which, as an image lag phenomenon, afterglow occurs due to the fact that, even when radiation of X-rays is stopped, the luminescence of the scintillator does not cease or image lag occurs due to, for example, remaining charge transfer of an imaging element may arise. Such a phenomenon is called “bright burn”. Since this phenomenon causes an artifact or a subject's image lag to occur in an image obtained by the radiation detection unit 200 and it takes time for the image to become normal again, it becomes necessary to perform correction to remove bright burn. The image lag decreases over time.

The control apparatus 400 includes a communication control unit 401, a radiation imaging apparatus control unit 402, a radiation imaging application 403, a radiation generation apparatus control unit 404, and a power source 407. The communication control unit 401 controls communications between the control apparatus 400 and the radiation imaging apparatus 100 and communications between the control apparatus 400 and the radiation generation apparatus 300. The radiation imaging apparatus control unit 402 performs control of, for example, image acquisition timing and conditions for the radiation imaging apparatus 100. The radiation imaging application 403 performs, for example, collection and displaying of a radiation image transmitted from the radiation imaging apparatus 100. The radiation generation apparatus control unit 404 performs control of, for example, a radiation condition for radiation for the radiation generation apparatus 300.

The display unit 405 displays a radiation image and image capturing information. The control apparatus operation UI 406 is, for example a keyboard and a mouse and is a UI used to operate the control apparatus 400. The radiation generation apparatus operation UI 302 is, for example a keyboard and a mouse and is a UI used to operate the radiation generation apparatus 300.

Exchange of information is enabled by any one of a communication wire, a dedicated signal wire, and a wireless communication or a plurality of communication methods to be performed between the control apparatus 400 and the radiation imaging apparatus 100 and between the control apparatus 400 and the radiation generation apparatus 300. The communication wire is, for example, a cable wire using a standard such as RS-232C, Universal Serial Bus (USB), or a local area network. Control communication for, for example, image data, image acquisition condition setting, or apparatus status acquisition is performed between the control apparatus 400 and the radiation imaging apparatus 100. Moreover, control communication for, for example, setting of a radiation irradiation condition, apparatus status acquisition, or actual irradiation information is performed between the control apparatus 400 and the radiation generation apparatus 300.

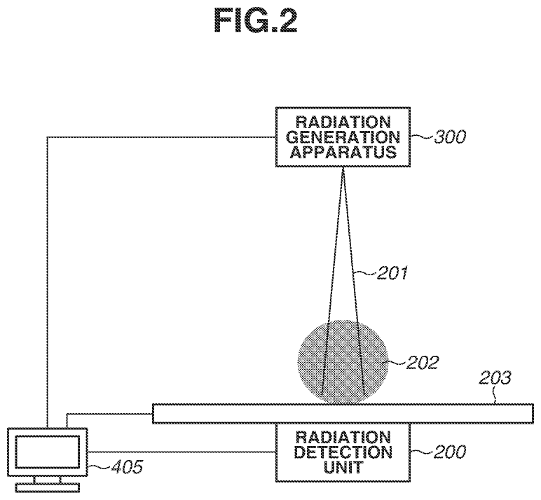

FIG. 2 is a diagram illustrating a configuration example of a radiation inspection system for non-destructive inspection. The radiation inspection system includes the radiation imaging system 120 illustrated in FIG. 1. The radiation inspection system includes the radiation generation apparatus 300, a conveyor belt 203, a subject 202, the radiation detection unit 200, and the display unit 405. The radiation generation apparatus 300 radiates radiation 201. The subject 202 comes flowing on the conveyor belt 203. The radiation detection unit 200 converts incident radiation into an electrical signal to output a radiation image. The display unit 405 displays a radiation image and image capturing information.

In the case of, after performing image capturing of the subject 202, performing image capturing of another subject, the radiation inspection system moves the conveyor belt 203 to move the subject 202, thus performing image capturing of another subject. In a case where a bright burn phenomenon has occurred in a radiation image, the radiation inspection system activates the conveyor belt 203 to move the subject 202 and causes the radiation generation apparatus 300 to radiate radiation 201 in a state in which the subject 202 does not exist on the trajectory of the radiation 201, thus being able to perform gain calibration. Moreover, in a case where a bright burn phenomenon has occurred in a radiation image, if there is an inspection for which it is not desirable to perform gain calibration, the radiation inspection system is also able to turn off the gain calibration function with the setting of the radiation generation apparatus 300.

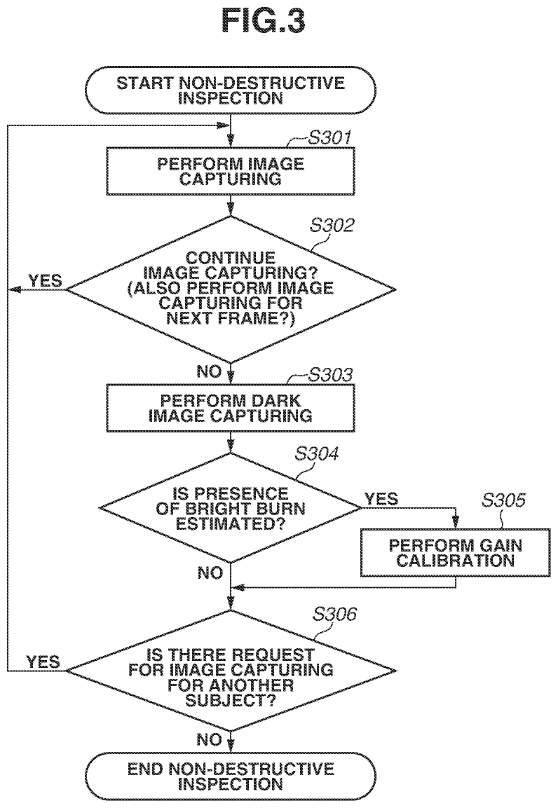

FIG. 3 is a flowchart illustrating a control method for the radiation imaging system 120. Here, the storage unit 106 is assumed to preliminarily retain the offset correction data 108 and the gain correction data 109. Therefore, if the storage unit 106 does not currently retain the offset correction data 108, although not illustrated, first, the operator operates the control apparatus 400 to perform offset correction data generation processing. Similarly, if the storage unit 106 does not currently retain the gain correction data 109, although not illustrated, first, the operator operates the control apparatus 400 to perform gain correction data generation processing.

Moreover, although not illustrated, prior to step S301, the operator performs setting of an inspection target and selection of, for example, an image capturing method via the control apparatus operation UI 406. The radiation imaging apparatus control unit 402 generates a radiation imaging apparatus control signal (for example, an image capturing mode number in which a frame rate and an image size have been preliminarily determined) based on the selection performed by the operator. Then, the communication control unit 401 transmits the radiation imaging apparatus control signal to the communication unit 112 of the radiation imaging apparatus 100.

The control unit 101 receives the radiation imaging apparatus control signal from the communication unit 112 and controls the radiation image acquisition unit 102 in such a way as to drive the radiation detection unit 200 with a period corresponding to the frame rate of the radiation imaging apparatus control signal. At this time, the radiation image acquisition unit 102 performs a resetting operation for the radiation image acquisition unit 102.

After the preparation for radiating radiation by the radiation generation apparatus 300 and the preparation for detecting radiation by the radiation imaging apparatus 100 have been completed, in response to a switch of the radiation generation apparatus operation UI 302 being pressed by the operator, the radiation source 301 starts radiating radiation under the control of the radiation generation apparatus 300.

In step S301, the radiation image acquisition unit 102 acquires a radiation image generated by the radiation detection unit 200 in a state in which radiation has been radiated from the radiation source 301 (in a radiation irradiated state), by a reading-out operation for electric charge of the respective imaging elements of the radiation detection unit 200. This radiation image is an image generated in a state in which a subject is present. Then, the radiation image acquisition unit 102 stores the acquired radiation image as a radiation image 107 in the storage unit 106.

Then, the control unit 101 controls the offset correction unit 104 and the gain correction unit 105 of the image processing unit 103 to perform offset correction and gain correction on the radiation image 107. At this time, the offset correction unit 104 performs offset correction on the radiation image 107 using the offset correction data 108, which is preliminarily stored as correction data in the storage unit 106. The gain correction unit 105 performs gain correction on the radiation image 107 using the gain correction data 109, which is preliminarily stored as correction data in the storage unit 106. After performing image processing on the radiation image 107, the control unit 101 controls the communication unit 112 to transfer the radiation image 107 subjected to image processing to the communication control unit 401.

In step S302, the control unit 101 included in the radiation imaging apparatus 100 determines whether to continue image capturing. At this time, for example, the control unit 101 checks the communication unit 112 to check the presence or absence of an image capturing stopping request communication transmitted from the radiation imaging apparatus control unit 402 included in the control apparatus 400, thus performing the above-mentioned determination. If the image capturing stopping request communication is absent, the control unit 101 determines to continue image capturing, and, if the image capturing stopping request communication is present, the control unit 101 determines not to continue image capturing. If it is determined not to continue image capturing (NO in step S302), the control unit 101 advances the processing to step S303. If it is determined to continue image capturing (YES in step S302), the control unit 101 returns the processing to step S301.

In step S301, the radiation image acquisition unit 102 controls the radiation detection unit 200 to acquire a radiation image for the next frame formed from radiation radiated from the radiation source 301, by a reading-out operation for electric charge of the respective imaging elements of the radiation detection unit 200. Then, the radiation image acquisition unit 102 retains the acquired radiation image as a radiation image 107 in the storage unit 106. Then, the control unit 101 performs image processing on the radiation image 107 again and transfers the radiation image 107 subjected to image processing to the communication control unit 401. After that, in step S302, the control unit 101 determines whether to continue image capturing again. With this processing, the radiation image acquisition unit 102 acquires radiation images 107 for a plurality of frames.

In step S303, it means that the communication unit 112 included in the radiation imaging apparatus 100 has received an image capturing stopping request communication from the radiation imaging apparatus control unit 402 included in the control apparatus 400. Accordingly, it means that the radiation imaging application 403 is requesting the radiation generation apparatus 300 to stop radiating radiation, so that a state in which radiation is not being radiated from the radiation source 301 is brought about.

In a state in which radiation is not being radiated (a radiation non-irradiated state), the radiation image acquisition unit 102 controls the radiation detection unit 200 and, before starting a resetting operation for the radiation detection unit 200, acquires an image generated by the radiation detection unit 200. This image is an FPN image (dark image), which is an image obtained in a state in which radiation is not being radiated. The control unit 101 stores this image as an immediately-after-image-capturing FPN image 110 in the storage unit 106.

To acquire the immediately-after-image-capturing FPN image 110, the radiation image acquisition unit 102 controls the radiation detection unit 200 on the same operation condition as that used when image capturing has been performed in step S301, and thus acquires the immediately-after-image-capturing FPN image 110. Alternatively, the radiation image acquisition unit 102 can control the radiation detection unit 200 on an operation condition different from that used when image capturing has been performed in step S301 and thus acquire the immediately-after-image-capturing FPN image 110.

As the timing for acquiring the immediately-after-image-capturing FPN image 110 is a shorter span of time after image capturing, it is possible to estimate the presence or absence of bright burn with higher accuracy in bright burn estimation in step S304 described below.

Accordingly, as an example of the different operation condition used to acquire the immediately-after-image-capturing FPN image 110, it is possible to make the frame rate faster. Then, after acquiring the immediately-after-image-capturing FPN image 110, the radiation image acquisition unit 102 starts a resetting operation for the radiation detection unit 200.

As mentioned above, a resetting operation for the radiation detection unit 200 is not performed between the acquisition of the radiation image 107 in step S301 and the acquisition of the immediately-after-image-capturing FPN image 110 in step S303 but is performed after the acquisition of the immediately-after-image-capturing FPN image 110.

Moreover, the operation condition for generating the immediately-after-image-capturing FPN image 110 by the radiation detection unit 200 in step S303 is the same as the operation condition for generating the radiation image 107 by the radiation detection unit 200 in step S301. Furthermore, the frame rate for generating the immediately-after-image-capturing FPN image 110 by the radiation detection unit 200 in step S303 can be set faster than the frame rate for generating the radiation image 107 by the radiation detection unit 200 in step S301.

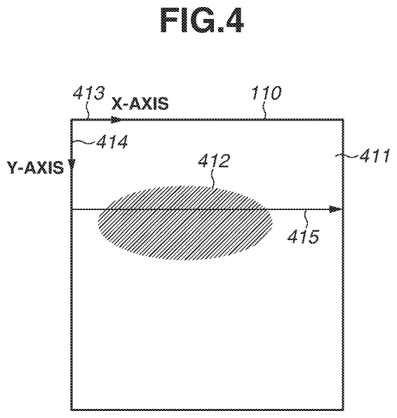

The immediately-after-image-capturing FPN image 110 acquired here is supposed to be an image in which a hollow region 411, in which no subject has present in the immediately-after-image-capturing FPN image 110, and an image lag region 412, in which a subject has been present once, are distributed as illustrated in FIG. 4. Naturally, the hollow region 411 is larger in pixel value than the image lag region 412. After storing the immediately-after-image-capturing FPN image 110 in the storage unit 106, the control unit 101 advances the processing to step S304.

In step S304, the bright burn estimation unit 111 estimates the presence or absence of bright burn in the scintillators of the radiation detection unit 200 based on the immediately-after-image-capturing FPN image 110 acquired in step S303. Here, first, the bright burn estimation unit 111 calculates an in-plane pixel distribution of the immediately-after-image-capturing FPN image 110. The method of calculating the in-plane pixel distribution includes, for example, as illustrated in FIG. 4, performing scanning on the immediately-after-image-capturing FPN image 110 along a horizontal axis scanning line 413 for each vertical row 414, thus calculating an in-plane pixel distribution.

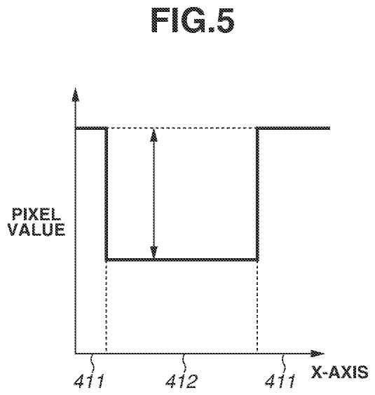

Here, when, with regard to a horizontal axis scanning line 415 having the hollow region 411 and the image lag region 412, the pixel distribution of the horizontal axis scanning line 415 has been calculated, the pixel value varies greatly between the hollow region 411 and the image lag region 412 as illustrated in FIG. 5. In this way, in the in-plane pixel distribution of the immediately-after-image-capturing FPN image 110, in a case where a region the varied value in pixel value of which is greater than or equal to a specific threshold value is present, the bright burn estimation unit 111 estimates that bright burn in the scintillators of the radiation detection unit 200 is present in image capturing performed just before in step S301. If it is estimated that such bright burn is present (YES in step S304), the bright burn estimation unit 111 advances the processing to step S305. On the other hand, in a case where, in the in-plane pixel distribution of the immediately-after-image-capturing FPN image 110, any region the varied value in pixel value of which is greater than or equal to the specific threshold value is not present, the bright burn estimation unit 111 estimates that bright burn in the scintillators of the radiation detection unit 200 is not present (NO in step S304), the bright burn estimation unit 111 advances the processing to step S306.

In the above-mentioned way, in a case where the difference in pixel value in the immediately-after-image-capturing FPN image 110 is greater than or equal to a threshold value, the bright burn estimation unit 111 estimates that bright burn in the scintillators is present, and, in a case where the difference in pixel value in the immediately-after-image-capturing FPN image 110 is neither greater than or equal to the threshold value, the bright burn estimation unit 111 estimates that bright burn in the scintillators is not present. If it is estimated that bright burn in the scintillators is present, the bright burn estimation unit 111 advances the processing to step S305. If it is estimated that bright burn in the scintillators is not present, the bright burn estimation unit 111 advances the processing to step S306.

In step S305, the radiation image acquisition unit 102 controls the radiation detection unit 200 to perform the following gain calibration. In the gain calibration, with regard to predetermined radiation irradiation setting, the radiation generation apparatus 300 controls radiation irradiation of the radiation source 301. The radiation image acquisition unit 102 acquires a plurality of radiation irradiated images generated by the radiation detection unit 200 in a state in which there is no subject and in a radiation irradiated state. After that, the gain correction unit 105 generates gain correction data based on an average value of the acquired plurality of radiation irradiated images and updates the gain correction data 109 stored in the storage unit 106 with the generated gain correction data. After that, the gain correction unit 105 advances the processing to step S306.

In step S306, the control unit 101 included in the radiation imaging apparatus 100 determines whether to perform image capturing for another subject. At this time, for example, the control unit 101 checks the communication unit 112 to check the presence or absence of an image capturing starting request communication for another subject transmitted from the radiation imaging apparatus control unit 402 included in the control apparatus 400, thus performing the above-mentioned determination. In a case where an image capturing starting request communication for another subject is present, the control unit 101 determines to perform image capturing for another subject, and, in a case where an image capturing starting request communication for another subject is not present, the control unit 101 determines not to perform image capturing for another subject.

If it is determined to perform image capturing for another subject (YES in step S306), the control unit 101 returns the processing to step S301, in which the radiation image acquisition unit 102 starts a reading-out operation for electric charge of the respective imaging elements of the radiation detection unit 200 again, thus acquiring a radiation image. If it is determined not to perform image capturing for another subject (NO in step S306), the control unit 101 ends the processing in the flowchart of FIG. 3.

As described above, according to the first exemplary embodiment, when bright burn has occurred in scintillators due to a large quantity of radiation irradiation, the radiation imaging system 120 estimates the occurrence of bright burn, updates correction data, and corrects a radiation image using the correction data. This enables the radiation imaging system 120 to continue image capturing while reducing the influence of bright burn.

Furthermore, each of the offset correction data 108 and the immediately-after-image-capturing FPN image 110 can be a single image or can be an average image of a plurality of images.

Moreover, when, in step S304, the bright burn estimation unit 111 estimates the presence or absence of bright burn based on the immediately-after-image-capturing FPN image 110, the bright burn estimation unit 111 can perform image processing on the immediately-after-image-capturing FPN image 110 and can estimate the presence or absence of bright burn based on the image subjected to image processing. For example, the bright burn estimation unit 111 can control the offset correction unit 104 to perform offset correction on the immediately-after-image-capturing FPN image 110 using the offset correction data 108 and can estimate the presence or absence of bright burn based on the corrected image. This enables the control unit 101 to generate an image with a noise component thereof reduced from the immediately-after-image-capturing FPN image 110, so that the estimate accuracy in bright burn estimation increases.

Moreover, when, in step S305, performing gain calibration, the control unit 101 can control the communication unit 112 to transmit a bright burn occurrence notification signal to the control apparatus 400, thus notifying the user of the occurrence of bright burn. The communication unit 112 serves as a notification unit and notifies the control apparatus 400 of the occurrence of bright burn. At this time, after the communication control unit 401 of the control apparatus 400 receives the bright burn occurrence notification signal, the radiation imaging application 403 displays an alert screen for the occurrence of bright burn on the display unit 405.

Moreover, at this time, the radiation imaging application 403 can display a selection screen for selecting whether to perform gain calibration on the display unit 405 and cause the user to perform selection. At this time, the user operates the control apparatus operation UI 406 to select whether to perform gain calibration. The radiation imaging application 403 transmits a result of such selection to the communication unit 112 of the radiation imaging apparatus 100. The control unit 101 of the radiation imaging apparatus 100 checks the selection result received by the communication unit 112 and, in a case where an instruction for performing gain calibration has been selected, the control unit 101 performs gain calibration in step S305 and then advances the processing to step S306. In a case where an instruction for not performing gain calibration has been selected, the control unit 101 can advance the processing directly to step S306 without performing gain calibration.

Furthermore, while, here, as a method for notification to the user, the bright burn occurrence notification signal has been mentioned as an example, a notification UI (not illustrated), such as a light-emitting diode (LED) or a buzzer, included in the radiation imaging apparatus 100 can be used. Moreover, instead of displaying an alert screen for the occurrence of bright burn on the display unit 405, the radiation imaging application 403 can perform notification by sound using an audio output unit (not illustrated) included in the control apparatus 400.

As described above, according to the first exemplary embodiment, the bright burn estimation unit 111 estimates the presence or absence of bright burn in scintillators due to a large quantity of radiation irradiation based on the immediately-after-image-capturing FPN image 110. The gain correction unit 105 updates the gain correction data 109 only in a case where bright burn is present and performs correction using the updated gain correction data 109. This enables continuing image capturing while reducing the influence of bright burn.

In the case of the first exemplary embodiment, at the time of inspection, offset correction is performed with use of offset correction data 108 preliminarily generated prior to image capturing in every frame. In the case of a second exemplary embodiment, the control unit 101 generates offset correction data 108 in every frame to perform offset correction. In this case, the control unit 101 acquires a radiation image for one frame generated by the radiation detection unit 200 in a radiation irradiated state, and stores the acquired radiation image as a radiation image 107 in the storage unit 106. After that, the control unit 101 acquires an image for one frame generated by the radiation detection unit 200 in a radiation non-irradiated state, and stores the acquired image as offset correction data 108 in the storage unit 106. After that, the control unit 101 controls the offset correction unit 104 of the image processing unit 103. The offset correction unit 104 performs offset correction on the frame of the radiation image 107 based on the frame of the offset correction data 108.

In this case, if it is determined to continue image capturing in step S302, the control unit 101 repeats the acquisition of a radiation image 107 and the acquisition of offset correction data 108 a plurality of times. If it is determined not to continue image capturing in step S302, the control unit 101 can advance the processing to step S304 without performing step S303.

In step S304, the radiation image acquisition unit 102 starts a resetting operation for the radiation detection unit 200. The resetting operation for the radiation detection unit 200 is not performed during the acquisition of the radiation image 107 and the acquisition of the offset correction data 108 being repeated a plurality of times but is performed after the acquisition of the last frame of the offset correction data 108. The bright burn estimation unit 111 performs estimation of the presence or absence of bright burn based on, instead of the immediately-after-image-capturing FPN image 110, the offset correction data 108 acquired in the last frame. Since the offset correction data 108 in the last frame is an FPN image which is shorter in the passage of time from the end of image capturing, the variation in pixel value becomes larger between the hollow region 411 and the image lag region 412 illustrated in FIG. 5, so that the accuracy in bright burn estimation increases.

In this case, too, when, in step S304, the bright burn estimation unit 111 estimates bright burn based on the offset correction data 108, the bright burn estimation unit 111 can perform image processing on the offset correction data 108 and can estimate the presence or absence of bright burn based on the image subjected to image processing.

For example, although not illustrated, prior to step S301, the radiation image acquisition unit 102 preliminarily acquires an image generated by the radiation detection unit 200 in a radiation non-irradiated state, and stores the acquired image as before-image-capturing offset correction data in the storage unit 106. The before-image-capturing offset correction data is not immediately-after-image-capturing offset correction data and, is, therefore, not subjected to bright burn. Then, in step S304, the bright burn estimation unit 111 controls the offset correction unit 104. The offset correction unit 104 performs offset correction by performing processing for subtracting the before-image-capturing offset correction data stored in the storage unit 106 from the last frame of the offset correction data 108. Then, the bright burn estimation unit 111 estimates the presence or absence of bright burn based on the image subjected to such offset correction. Furthermore, this before-image-capturing offset correction data is a before-image-capturing FPN image, and, as with the offset correction data 108 in the first exemplary embodiment, can be a single image acquired in a radiation non-irradiated state or can be an average image of a plurality of images.

This processing is also applicable to the first exemplary embodiment. The bright burn estimation unit 111 estimates the presence or absence of bright burn in the scintillators based on an image obtained by performing processing for subtracting the above-mentioned before-image-capturing offset correction data from the immediately-after-image-capturing FPN image 110.

In the method discussed in Japanese Patent Application Laid-Open No. 2003-185752, in a case where pixel values have been saturated by a large quantity of radiation irradiation as in non-destructive inspection, it is not possible to correctly estimate the amount of bright burn from an image. Therefore, unless gain correction for a plane detector is performed, it may be impossible to immediately remove an artifact caused by bright burn or image lag of a subject subjected to image capturing.

A third exemplary embodiment is directed to enabling performing accurate gain correction even if bright burn occurs in a radiation imaging apparatus. According to the third exemplary embodiment, it is possible to perform accurate gain correction even if bright burn occurs in a radiation imaging apparatus.

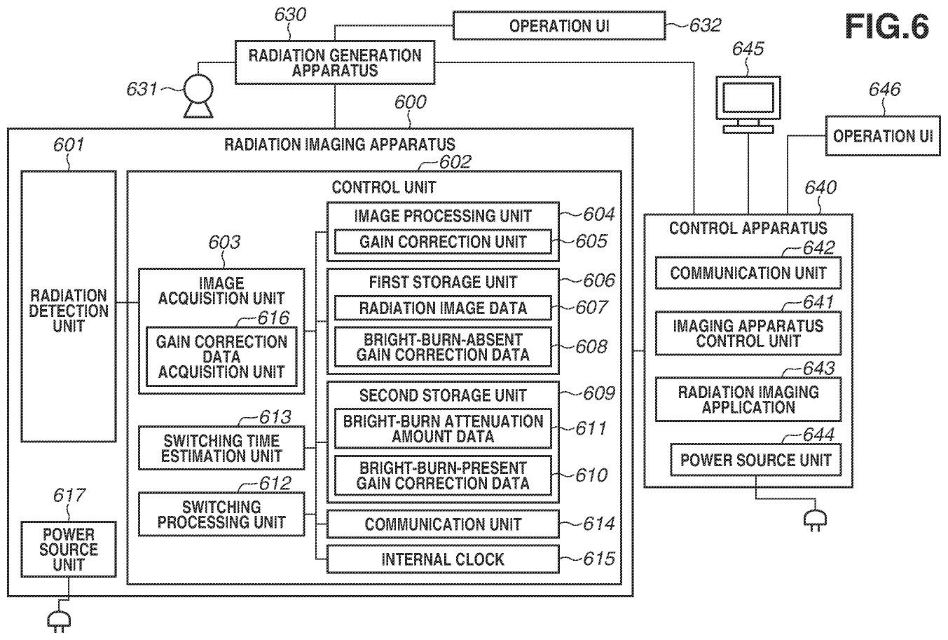

FIG. 6 is a diagram illustrating a configuration example of a radiation imaging system according to the third exemplary embodiment. The radiation imaging system includes a radiation imaging apparatus 600, which includes a radiation detection unit 601, a radiation generation apparatus 630, which controls a radiation source 631 for radiating radiation, and a control apparatus 640, which controls the radiation imaging apparatus 600 and the radiation generation apparatus 630.

The radiation imaging apparatus 600 includes the radiation detection unit 601, a control unit 602, and a power source unit 617. The radiation detection unit 601 detects incident radiation and generates image data corresponding to the dose of the detected radiation. In the radiation detection unit 601, a plurality of pixels each including a conversion element configured to include, for example, a scintillator (phosphor) for converting incident radiation into light (for example, visible light) and a photoelectric conversion element for converting the light generated by the scintillator into an electrical signal is arranged in a two-dimensional array manner.

The control unit 602 controls image capturing and a communication operation in the radiation imaging apparatus 600. The control unit 602 includes an image acquisition unit 603, an image processing unit 604, a first storage unit 606, a second storage unit 609, a switching processing unit 612, a switching time estimation unit 613, a communication unit 614, and an internal clock 615.

The image acquisition unit 603 acquires, from the radiation detection unit 601, image data including radiation image data corresponding to the irradiation of radiation. The image acquisition unit 603 includes a gain correction data acquisition unit 616, which acquires gain correction data from the radiation detection unit 601. The image processing unit 604 performs image processing on an image acquired from the radiation detection unit 601. The image processing unit 604 includes a gain correction unit 605, which corrects, using the gain correction data, a radiation image acquired by performing image capturing.

The first storage unit 606 stores, for example, radiation image data 607 and bright-burn-absent gain correction data 608 which have been acquired. The bright-burn-absent gain correction data 608 is gain correction data which has been acquired by performing image capturing while radiating radiation in a state in which bright burn is not occurring and in a state in which no subject is present. The second storage unit 609 stores, for example, bright-burn-present gain correction data 610 and bright-burn attenuation amount data 611. The bright-burn-present gain correction data 610 is gain correction data which has been acquired by performing image capturing while radiating radiation in a state in which bright burn is occurring and in a state in which no subject is present. The bright-burn attenuation amount data 611 is data indicating the attenuation amount of bright burn which has measured, for example, at the time of factory inspection or at the time of installment of the radiation imaging apparatus 600. Furthermore, the first storage unit 606 and the second storage unit 609 can be configured as a single storage unit.

The switching processing unit 612 performs processing concerning switching of gain correction data to be used for gain correction of the captured radiation image. The switching processing unit 612 makes a determination as to whether to switch gain correction data to be used, and performs switching of gain correction data depending on a result of the determination. For example, the switching processing unit 612 determines whether a predetermined switching condition is satisfied, and, if it is determined that the switching condition is satisfied, the switching processing unit 612 switches gain correction data to be used. The switching time estimation unit 613 estimates a switching time for gain correction data based on the bright-burn attenuation amount data 611 stored in the second storage unit 609. The communication unit 614 controls communication with the control apparatus 640. The internal clock 615 acquires, for example, image capturing time and an elapsed time. The power source unit 617 supplies electric power to each unit included in the radiation imaging apparatus 600.

The control unit 602 can read out, for example, a program stored in, for example, the first storage unit 606 and can perform control of the entire radiation imaging apparatus 600 based on, for example, the read-out program. Alternatively, the control unit 602 can perform control of the radiation imaging apparatus 600 with a control signal generation circuit configured with, for example, an application specific integrated circuit (ASIC), or can implement control of the entire radiation imaging apparatus 600 with both the program and the control circuit.

The radiation generation apparatus 630 controls the radiation source 631. The radiation source 631 is controlled by the radiation generation apparatus 630 and radiates radiation to the radiation imaging apparatus 600. The radiation generation apparatus 630 is equipped with an operation UI 632, which is used to operate the radiation generation apparatus 630. The operation UI 632 includes, for example, a keyboard and a mouse. Via the operation UI 632, the user performs, for example, setting of an irradiation condition for radiation and issuance of an instruction for irradiation of radiation.

The control apparatus 640 includes an imaging apparatus control unit 641, a communication unit 642, a radiation imaging application 643, a power source unit 644, a display unit 645, and an operation UI 646. The imaging apparatus control unit 641 performs control of, for example, image acquisition timing and conditions for the radiation imaging apparatus 600. The communication unit 642 controls communication with the radiation imaging apparatus 600 and the radiation generation apparatus 630. The radiation imaging application 643 controls, for example, collection and displaying of a captured image transmitted from the radiation imaging apparatus 600, reception of an image capturing order, and registration of image capturing information. The power source unit 644 supplies electric power to each unit included in the control apparatus 640. The display unit 645 displays a captured image and image capturing information. The operation UI 646 is a user interface which is used to operate the radiation imaging application 643. The operation UI 646 includes, for example, a keyboard and a mouse.

Here, the communication between the control apparatus 640 and the radiation imaging apparatus 600 and the communication between the control apparatus 640 and the radiation generation apparatus 630 can be, for example, a cable connection communication using a standard such as RS-232C, USB, or Ethernet. Moreover, the communication between the control apparatus 640 and the radiation imaging apparatus 600 and the communication between the control apparatus 640 and the radiation generation apparatus 630 can be a communication using a dedicated signal wire or a wireless communication. Moreover, the communication between the control apparatus 640 and the radiation imaging apparatus 600 and the communication between the control apparatus 640 and the radiation generation apparatus 630 can be a combination of such communications. Between the control apparatus 640 and the radiation imaging apparatus 600, for example, control communications for, for example, image data, image acquisition condition settings, and apparatus status acquisition are performed.

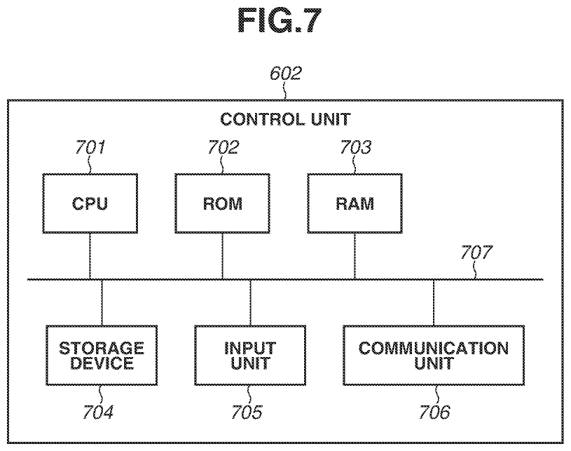

FIG. 7 is a diagram illustrating a hardware configuration example of the control unit 602 of the radiation imaging apparatus 600.

The control unit 602 includes a central processing unit (CPU) 701, a read-only memory (ROM) 702, a random access memory (RAM) 703, a storage device 704, an input unit 705, a communication unit 706, and a bus 707. The CPU 701, the ROM 702, the RAM 703, the storage device 704, the input unit 705, and the communication unit 706 are interconnected via the bus 707 in such a way as to be able to communicate with each other.

The CPU 701 reads out a control program stored in the ROM 702 to perform various processing operations, and thus performs control of the entire radiation imaging apparatus 600. The RAM 703 is used as a temporary storage region such as a main memory or work area for the CPU 701. The storage device 704 is, for example, a hard disk drive (HDD) or a solid state drive (SSD), and stores, for example, various pieces of data and various programs. The input unit 705 receives, as inputs, radiation image data acquired by image capturing and gain correction data. The communication unit 706 performs processing for communication with the control apparatus 640.

For example, the above-mentioned functions of the control unit 602 and processing operations thereof described below are implemented by the CPU 701 reading out a program stored in the ROM 702 or the storage device 704 and executing the read-out program.

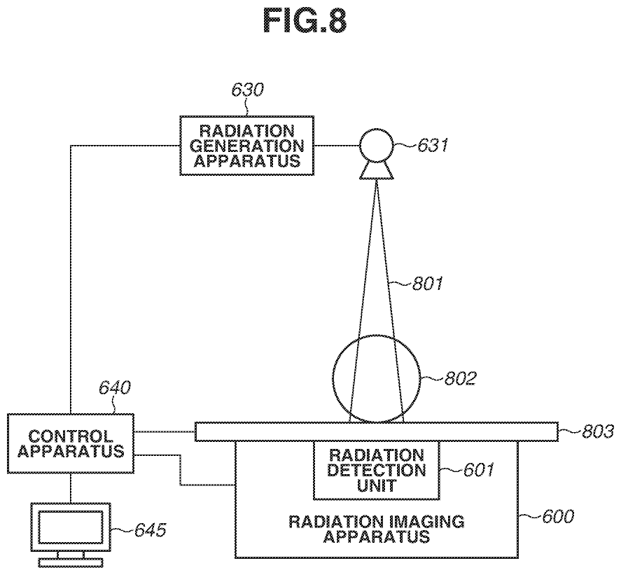

FIG. 8 is a diagram illustrating a configuration example of an inspection apparatus to which the radiation imaging system in the third exemplary embodiment is applied. In FIG. 8, constituent elements having the same functions as those of the constituent elements illustrated in FIG. 6 are assigned the respective same reference characters as those of the constituent elements illustrated in FIG. 6. In FIG. 8, radiation 801, such as X-rays, radiated from the radiation source 631 is illustrated. A subject 802 serves as an inspection target, and a conveyor belt 803, which is capable of moving the subject 802, controls the position of the subject 802. The inspection apparatus illustrated in FIG. 8 is able to, in a case where a bright burn phenomenon has occurred in a captured image that is based on image data acquired from the radiation detection unit 601, cause the conveyor belt 803 to operate and cause the radiation 801 to be radiated onto a position where the subject 802 is not present, thus performing gain adjustment. Moreover, the inspection apparatus illustrated in FIG. 8 is able to select whether to perform gain adjustment, and is also able to, in a case where, when a bright burn phenomenon has occurred in a captured image, there is an inspection the gain adjustment for which is not intended to be performed, turn off the gain adjustment function with setting of the radiation generation apparatus 630.

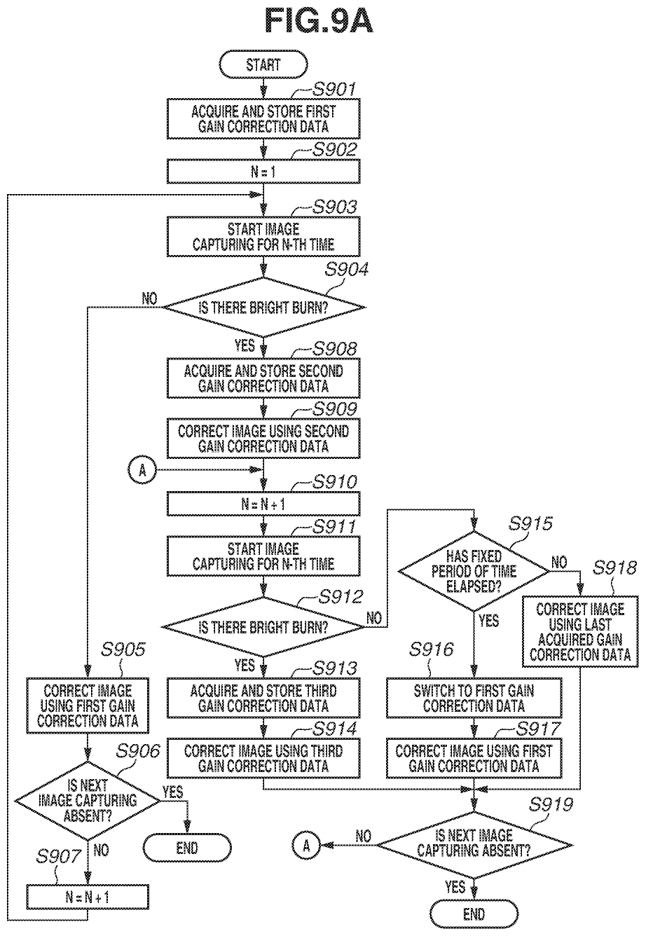

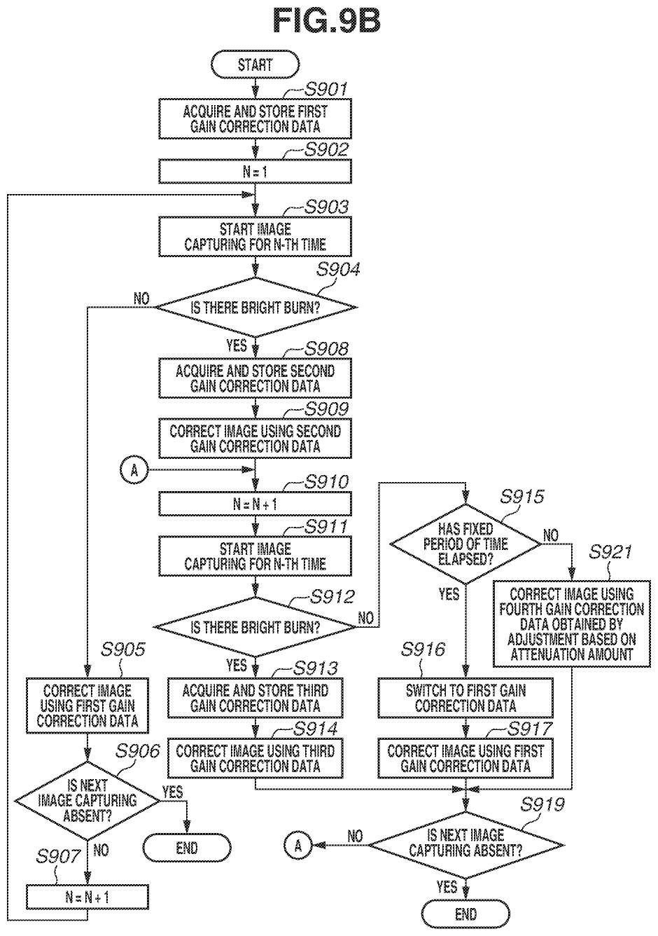

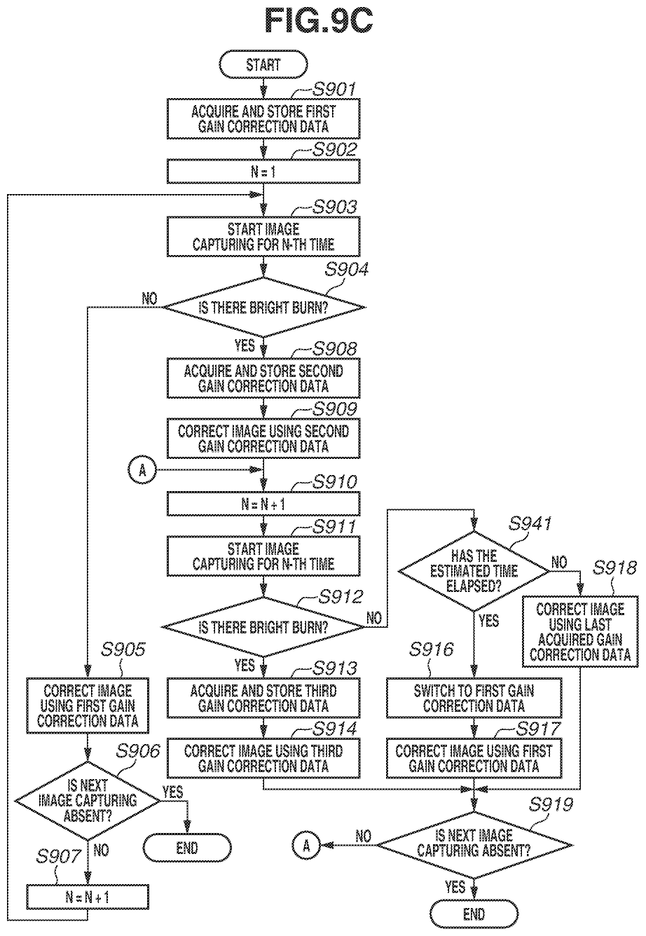

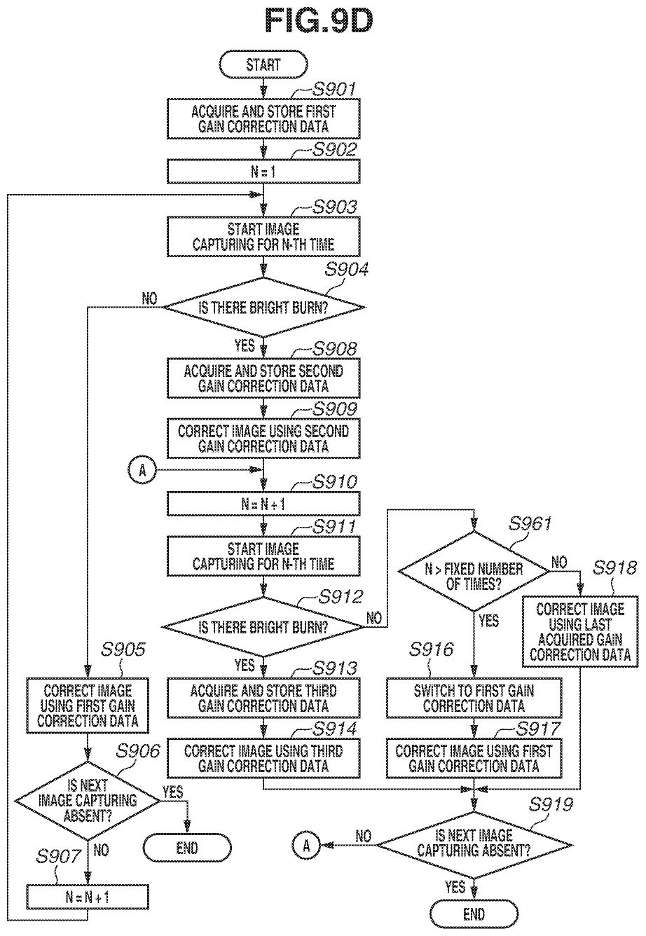

A processing example of updating and switching of gain correction data in the third exemplary embodiment is described with reference to a flowchart illustrated in FIG. 9A.

In step S901, the gain correction data acquisition unit 616 of the image acquisition unit 603 performs gain calibration in a state in which bright burn is not occurring and acquires and stores first gain correction data. The gain correction data acquisition unit 616 acquires first gain correction data by performing image capturing while radiating radiation in a state in which no subject is present, and stores the acquired first gain correction data as bright-burn-absent gain correction data 608 in the first storage unit 606.

In step S902, the control unit 602 sets the number of times of image capturing N to an initial value. In the third exemplary embodiment, the number of times of image capturing N, the initial value of which is set to “1”, is assumed to be incremented one by one each time image capturing of a subject is performed.

In step S903, the control unit 602 starts image capturing while radiating radiation onto a subject, so that the radiation imaging apparatus 600 performs image capturing for the N-th time. After image capturing for the N-th time ends, the control unit 602 advances the processing to step S904.

In step S904, the switching processing unit 612 determines whether there is bright burn in an image that is based on image data acquired from the radiation detection unit 601 in image capturing performed in step S903. For example, the estimation of the presence or absence of bright burn is performed based on visual checking of a captured image or a dark image (an image captured in a state in which radiation is not radiated), and, based on the result of estimation, the switching processing unit 612 determines whether there is bright burn in the image. If it is determined by the switching processing unit 612 that there is not bright burn (NO in step S904), the switching processing unit 612 advances the processing to step S905 without performing switching of gain correction data to be used. On the other hand, if it is determined by the switching processing unit 612 that there is bright burn (YES in step S904), the switching processing unit 612 advances the processing to step S908 to switch gain correction data to be used.

In step S905, the gain correction unit 605 of the image processing unit 604 corrects a radiation image captured in step S903 using the first gain correction data acquired in step S901.

In step S906, the control unit 602 determines whether there is next image capturing. If it is determined that there is next image capturing (NO in step S906), then in step S907, the control unit 602 increments the number of times of image capturing N by one, and then returns the processing to step S903. On the other hand, if it is determined that there is not next image capturing (YES in step S906), the control unit 602 ends the processing illustrated in FIG. 9A.

In step S908, the gain correction data acquisition unit 616 of the image acquisition unit 603 performs gain calibration in a state in which bright burn is occurring and acquires and stores second gain correction data. The gain correction data acquisition unit 616 acquires second gain correction data by performing image capturing while radiating radiation in a state in which no subject is present, and stores the acquired second gain correction data as bright-burn-present gain correction data 610 in the second storage unit 609.

In step S909, the gain correction unit 605 of the image processing unit 604 corrects a radiation image captured in step S903 using the second gain correction data acquired in step $908.

In step S910, the control unit 602 increments the number of times of image capturing N by one.

In step S911, the control unit 602 starts image capturing while radiating radiation onto a subject, so that the radiation imaging apparatus 600 performs image capturing for the N-th time. After image capturing for the N-th time ends, the control unit 602 advances the processing to step S912.

In step S912, the switching processing unit 612 determines whether there is bright burn in an image that is based on image data acquired from the radiation detection unit 601 in image capturing performed in step S911. Furthermore, in this step S912, the switching processing unit 612 determines whether there is new bright burn, which is different from the previously determined bright burn. If it is determined by the switching processing unit 612 that there is new bright burn (YES in step S912), the switching processing unit 612 advances the processing to step S913 to switch gain correction data to be used. On the other hand, if it is determined by the switching processing unit 612 that there is not new bright burn (NO in step S912), the switching processing unit 612 advances the processing to step S915.

In step S913, the gain correction data acquisition unit 616 of the image acquisition unit 603 performs gain calibration in a state in which bright burn is occurring and acquires and stores third gain correction data. The gain correction data acquisition unit 616 acquires third gain correction data by performing image capturing while radiating radiation in a state in which no subject is present, and stores the acquired third gain correction data as bright-burn-present gain correction data 610 in the second storage unit 609.

In step S914, the gain correction unit 605 of the image processing unit 604 corrects a radiation image captured in step S911 using the third gain correction data acquired in step S913. After the completion of step S914, the gain correction unit 605 advances the processing to step S919.

In step S915, the switching processing unit 612 determines whether a fixed period of time has elapsed from the acquisition of the previous gain correction data. If it is determined by the switching processing unit 612 that the fixed period of time has elapsed from the acquisition of the previous gain correction data (YES in step S915), the switching processing unit 612 advances the processing to step S916 to switch gain correction data to be used. On the other hand, if it is determined by the switching processing unit 612 that the fixed period of time has not elapsed from the acquisition of the previous gain correction data (NO in step S915), the switching processing unit 612 advances the processing to step S918.

In step S916, the switching processing unit 612 switches gain correction data to be used to the first gain correction data stored in the first storage unit 606.

In step S917, the gain correction unit 605 of the image processing unit 604 corrects a radiation image captured in step S911 using the first gain correction data. After the completion of step S917, the gain correction unit 605 advances the processing to step S919.

In step S918, the gain correction unit 605 of the image processing unit 604 corrects a radiation image captured in step S911 using the last acquired gain correction data. After the completion of step S918, the gain correction unit 605 advances the processing to step S919.

In step S919, the control unit 602 determines whether there is next image capturing. If it is determined that there is next image capturing (NO in step S919), the control unit 602 returns the processing to step S910. On the other hand, if it is determined that there is not next image capturing (YES in step S919), the control unit 602 ends the processing illustrated in FIG. 9A.

According to the third exemplary embodiment, in a case where bright burn has occurred, it is possible to perform accurate gain correction soon after the occurrence of bright burn by performing gain calibration to acquire new gain correction data and correcting a radiation image using the acquired gain correction data. Moreover, it is possible to perform accurate gain correction even after bright burn disappears, by, when a fixed period of time has elapsed from the occurrence of bright burn, performing switching to preliminarily stored bright-burn-absent gain correction data and correcting a radiation image using the bright-burn-absent gain correction data. Setting an estimated time taken until bright burn disappears as the fixed period of time enables preventing an image (inverted image) from becoming visible due to over correction.

While, in the above description, in a case where a fixed period of time has elapsed from the acquisition of the last gain correction data, the gain correction data to be used is switched to the first gain correction data, the gain correction data to be used can be switched to the first gain correction data in a case where a fixed period of time has elapsed after bright burn has occurred.

Furthermore, in the above-described processing illustrated in the flowchart of FIG. 9A, a radiation image is corrected directly using the last acquired gain correction data in correcting a radiation image in step S918. The third exemplary embodiment is not limited to this, and, for example, a radiation image can be corrected using gain correction data which has been obtained by adjusting the last acquired gain correction data based on the bright burn attenuation amount. FIG. 9B illustrates a processing example in the case of adjusting the last acquired gain correction data based on the bright burn attenuation amount. In FIG. 9B, steps for performing the same processing operations as those in steps illustrated in FIG. 9A are assigned the respective same reference characters as those in FIG. 9A.

The processing illustrated in FIG. 9B differs from the processing illustrated in FIG. 9A in that the processing operation in step S918 illustrated in FIG. 9A is replaced with a processing operation in step S921 illustrated in FIG. 9B. Processing operations other than the processing operation in step S921 are the same as those illustrated in FIG. 9A and are, therefore, omitted from description.

In the processing illustrated in FIG. 9B, in step S921, the gain correction unit 605 of the image processing unit 604 corrects a radiation image captured in step S911 using fourth gain correction data which has been obtained by adjusting the last acquired gain correction data based on the bright burn attenuation amount. Specifically, the gain correction unit 605 calculates the amount of bright burn from the time of acquisition of the bright-burn-absent first gain correction data and the time of acquisition of the last bright-burn-present second or third gain correction data. Moreover, the gain correction unit 605 preliminarily measures the bright-burn attenuation amount, for example, at the time of factory inspection or at the time of installation of the radiation imaging apparatus 600, and preliminarily stores data indicating the right-burn attenuation amount as the bright-burn attenuation amount data 611 in the second storage unit 609.

The gain correction unit 605 corrects a radiation image using fourth gain correction data calculated with use of the stored bright-burn attenuation amount data 611 and the second or third gain correction data. In this way, correcting a radiation image using gain correction data adjusted based on the attenuation amount enables performing accurate gain correction corresponding to the remaining amount of bright burn until bright burn disappears (a fixed period of time elapses).

Moreover, while, in the processing example illustrated in FIG. 9A, switching from gain correction data acquired after the occurrence of bright burn to the first gain correction data is performed in a case where a fixed period of time has elapsed from the acquisition of the last gain correction data, the third exemplary embodiment is not limited to this. For example, switching can be performed in a case where a time in which it has been estimated that bright burn disappears based on the bright-burn attenuation amount has elapsed. Moreover, for example, switching can be performed in a case where the number of times of image capturing performed since the acquisition of the last gain correction data or since the occurrence of bright burn has exceeded a fixed number of times. FIG. 9C illustrates a processing example in the case of performing switching in a case where a time in which it has been estimated that bright burn disappears based on the bright-burn attenuation amount has elapsed. Moreover, FIG. 9D illustrates a processing example in the case of performing switching in a case where the number of times of image capturing performed since the acquisition of the last gain correction data or since the occurrence of bright burn has exceeded a fixed number of times.

The processing illustrated in FIG. 9C differs from the processing illustrated in FIG. 9A in that the processing operation in step S915 illustrated in FIG. 9A is replaced with a processing operation in step S941 illustrated in FIG. 9C. Processing operations other than the processing operation in step S941 are the same as those illustrated in FIG. 9A and are, therefore, omitted from description.

In the processing illustrated in FIG. 9C, in step S941, the switching processing unit 612 determines whether a time in which it has been estimated that bright burn having occurred disappears based on the bright-burn attenuation amount has elapsed. If it is determined by the switching processing unit 612 that the estimated time has elapsed (YES in step S941), the switching processing unit 612 advances the processing to step S916 to switch gain correction data to be used to the first gain correction data stored in the first storage unit 606. On the other hand, if it is determined by the switching processing unit 612 that the estimated time has not elapsed (NO in step S941), the switching processing unit 612 advances the processing to step S918.

In step S941, for example, the switching time estimation unit 613 estimates a time in which bright burn disappears based on the amount of bright burn having occurred and the bright-burn attenuation amount data 611 stored in the second storage unit 609. Then, the switching processing unit 612 determines whether the estimated time in which bright burn disappears has elapsed, and, if it is determined that the estimated time has elapsed, the switching processing unit 612 advances the processing to step S916 to switch gain correction data to be used to the first gain correction data. This enables more accurately estimating a time in which bright burn disappears than performing switching to the first gain correction data in a case where a preliminarily determined fixed period of time has elapsed, and enables preventing an image (inverted image) from becoming visible due to over correction.

Moreover, the processing illustrated in FIG. 9D differs from the processing illustrated in FIG. 9A in that the processing operation in step S915 illustrated in FIG. 9A is replaced with a processing operation in step S961 illustrated in FIG. 9D. Processing operations other than the processing operation in step S961 are the same as those illustrated in FIG. 9A and are, therefore, omitted from description.

In the processing illustrated in FIG. 9D, in step S961, the switching processing unit 612 determines whether the number of times of image capturing performed since the acquisition of the last gain correction data or since the occurrence of bright burn has exceeded a fixed number of times. If it is determined by the switching processing unit 612 that the number of times of image capturing has exceeded the fixed number of times (YES in step S961), the switching processing unit 612 advances the processing to step S916 to switch gain correction data to be used to the first gain correction data stored in the first storage unit 606. On the other hand, if it is determined by the switching processing unit 612 that the number of times of image capturing has not exceeded the fixed number of times (NO in step S961), the switching processing unit 612 advances the processing to step S918. This enables performing accurate gain correction without performing complicated processing such as estimation from the time information or the bright-burn attenuation amount in the case of an inspection in which the scenario of image capturing (an image capturing mode and the number of times of image capturing) is previously determined, and enables preventing an image (inverted image) from becoming visible due to over correction.

Furthermore, while, in the examples illustrated in FIG. 9C and FIG. 9D, in step S918, the last acquired gain correction data in correcting a radiation image is used without any change, gain correction data which has been adjusted based on the attenuation amount can be used as illustrated in FIG. 9B. Moreover, the condition for switching from the gain correction data acquired after the occurrence of bright burn to the first gain correction data is not limited to each of the conditions illustrated in FIG. 9A, FIG. 9C, and FIG. 9D, but can be a combination of some or all of the conditions illustrated in FIG. 9A, FIG. 9C, and FIG. 9D in a selective manner.

The present disclosure can also be implemented by processing for supplying a program for implementing one or more functions of the above-described exemplary embodiments to a system or apparatus via a network or a storage medium and causing one or more processors in a computer of the system or apparatus to read out and execute the program. Moreover, the present disclosure can also be implemented by a circuit which implements one or more functions of the above-described exemplary embodiments (for example, an application specific integrated circuits (ASIC)).

Furthermore, each of the above-described exemplary embodiments merely represents a specific example in implementing the present disclosure, and should not be construed to limit the technical scope of the present disclosure. Thus, the present disclosure can be implemented in various forms without departing from the technical idea thereof or the principal features thereof.

The disclosure in each of the above-described exemplary embodiments includes, for example, the following configurations and methods.

### Configuration 1

A radiation imaging apparatus including:
a radiation detection unit including a scintillator for converting radiation into light and a photoelectric conversion element for converting light into electric charge and configured to generate an image;
an acquisition unit configured to acquire a first image generated by the radiation detection unit in a radiation irradiated state and, after that, acquire a second image generated by the radiation detection unit in a radiation non-irradiated state; and
an estimation unit configured to estimate presence or absence of bright burn in the scintillator based on the second image.

### Configuration 2

The radiation imaging apparatus as set forth in Configuration 1, wherein a resetting operation for the radiation detection unit is not performed between acquisition of the first image and acquisition of the second image and is performed after acquisition of the second image.

### Configuration 3

The radiation imaging apparatus as set forth in Configuration 1 or 2, wherein, in a case where a difference between pixel values in the second image is greater than or equal to a threshold value, the estimation unit estimates that bright burn in the scintillator is present, and, in a case where a difference between pixel values in the second image is neither greater than nor equal to the threshold value, the estimation unit estimates that bright burn in the scintillator is absent.

### Configuration 4

The radiation imaging apparatus as set forth in any one of Configurations 1 to 3, further including a first correction unit configured to correct the first image using first correction data, wherein, in a case where it is estimated by the estimation unit that bright burn in the scintillator is present, the first correction unit updates the first correction data.

### Configuration 5

The radiation imaging apparatus as set forth in Configuration 4, wherein, in a case where it is estimated by the estimation unit that bright burn in the scintillator is present, the acquisition unit acquires a third image generated by the radiation detection unit in a state in which no subject is present and in a radiation irradiated state, and
wherein, in a case where it is estimated by the estimation unit that bright burn in the scintillator is present, the first correction unit corrects the first correction data based on the third image.

### Configuration 6

The radiation imaging apparatus as set forth in Configuration 5, wherein the acquisition unit acquires a plurality of third images each corresponding to the third image, and
wherein the first correction unit updates the first correction data based on the plurality of third images.

### Configuration 7

The radiation imaging apparatus as set forth in any one of Configurations 1 to 6, wherein an operation condition for generation of the second image of the radiation detection unit is identical with an operation condition for generation of the first image of the radiation detection unit.

### Configuration 8

The radiation imaging apparatus as set forth in any one of Configurations 1 to 6, wherein a frame rate for generation of the second image of the radiation detection unit is faster than a frame rate for generation of the first image of the radiation detection unit.

### Configuration 9

The radiation imaging apparatus as set forth in any one of Configurations 1 to 8, wherein the estimation unit estimates the presence or absence of bright burn in the scintillator based on an image obtained by performing image processing on the second image.

### Configuration 10

The radiation imaging apparatus as set forth in any one of Configurations 1 to 3, further including a notification unit configured to issue a notification in a case where it is estimated by the estimation unit that bright burn in the scintillator is present.

### Configuration 11

The radiation imaging apparatus as set forth in Configuration 10, further including a first correction unit configured to correct the first image using first correction data,
wherein, in a case where an instruction responding to the notification issued by the notification unit is received, the first correction unit updates the first correction data.

### Configuration 12

The radiation imaging apparatus as set forth in any one of Configurations 1 to 11, wherein the first image is an image for a plurality of frames.

### Configuration 13

The radiation imaging apparatus as set forth in any one of Configurations 1 to 11, wherein each of the first image and the second image is an image for one frame,
wherein the acquisition unit repeats acquisition of a frame of the first image and acquisition of a frame of the second image a plurality of times, and
wherein the estimation unit estimates the presence or absence of bright burn in the scintillator based on a last frame of the second image.

### Configuration 14

The radiation imaging apparatus as set forth in Configuration 13, further including a second correction unit configured to correct a frame of the first image based on a frame of the second image.

### Configuration 15

The radiation imaging apparatus as set forth in Configuration 13 or 14, wherein a resetting operation for the radiation detection unit is not performed during acquisition of the first image and acquisition of the second being repeated a plurality of times but is performed after acquisition of a last frame of the second image.

### Configuration 16

The radiation imaging apparatus as set forth in any one of Configurations 1 to 15, wherein the estimation unit estimates the presence or absence of bright burn in the scintillator based on an image obtained by performing processing for subtracting a fourth image preliminarily generated by the radiation detection unit in a radiation non-irradiated state from the second image.

### Configuration 17

A radiation imaging apparatus including:
an acquisition unit configured to acquire a radiation image captured by a detection unit for detecting incident radiation and gain correction data; and
a gain correction unit configured to correct the radiation image using the gain correction data,
wherein, in a case where bright burn occurs in the detection unit, the gain correction unit corrects the radiation image using the gain correction data acquired by performing gain calibration after occurrence of bright burn.

### Configuration 18

The radiation imaging apparatus as set forth in Configuration 17, further including:
a switching unit configured to switch the gain correction data to be used for correction by the gain correction unit; and
a storage unit configured to store first gain correction data acquired when bright burn is not occurring,
wherein the switching unit switches the gain correction data to be used to the first gain correction data stored in the storage unit in response to at least one of an elapsed time since occurrence of bright burn and a number of times of image capturing performed since occurrence of bright burn.

### Configuration 19

The radiation imaging apparatus as set forth in Configuration 18, wherein, in a case where a predetermined time has elapsed after the gain correction data is acquired after occurrence of bright burn, the switching unit switches the gain correction data to be used to the first gain correction data.

### Configuration 20

The radiation imaging apparatus as set forth in Configuration 18 or 19, wherein, in a case where a predetermined time has elapsed after bright burn occurs, the switching unit switches the gain correction data to be used to the first gain correction data.

### Configuration 21

The radiation imaging apparatus as set forth in any one of Configurations 18 to 20, wherein, in a case where a time estimated from an amount of attenuation of bright burn has elapsed, the switching unit switches the gain correction data to be used to the first gain correction data.

### Configuration 22

The radiation imaging apparatus as set forth in any one of Configurations 18 to 21, wherein, in a case where a number of times of image capturing after occurrence of bright burn has exceeded a predetermined number of times, the switching unit switches the gain correction data to be used to the first gain correction data.

### Configuration 23

The radiation imaging apparatus as set forth in any one of Configurations 17 to 22, wherein, after occurrence of bright burn, the gain correction unit corrects the radiation image using the gain correction data obtained by adjusting, based on an amount of attenuation of bright burn, the gain correction data acquired by performing gain calibration after occurrence of bright burn.

### Configuration 24

The radiation imaging apparatus as set forth in any one of Configurations 17 to 23, wherein whether to perform the gain calibration in a case where bright burn has occurred in the detection unit is selectable.

### Configuration 25

A radiation imaging system including:
the radiation imaging apparatus as set forth in any one of Configurations 1 to 24; and
a radiation source configured to radiate radiation.

### Method 1

A control method for a radiation imaging apparatus including a radiation detection unit including a scintillator for converting radiation into light and a photoelectric conversion element for converting light into electric charge and configured to generate an image, the control method including:
acquiring a first image generated by the radiation detection unit in a radiation irradiated state and, after that, acquiring a second image generated by the radiation detection unit in a radiation non-irradiated state; and
estimating presence or absence of bright burn in the scintillator based on the second image.

### Method 2

A control method for a radiation imaging apparatus including a detection unit for detecting incident radiation, the control method including:
acquiring a radiation image captured by the detection unit and gain correction data;
correcting the radiation image using the gain correction data; and
in a case where bright burn occurs in the detection unit, correcting the radiation image using the gain correction data acquired by performing gain calibration after occurrence of bright burn.

### Storage Medium 1

A non-transitory computer-readable storage medium storing a program for causing a computer of a radiation imaging apparatus including a detection unit for detecting incident radiation to execute a control method including:
acquiring a radiation image captured by the detection unit and gain correction data;
correcting the radiation image using the gain correction data; and
in a case where bright burn occurs in the detection unit, correcting the radiation image using the gain correction data acquired by performing gain calibration after occurrence of bright burn.

According to the present disclosure, it is possible to estimate the presence or absence of bright burn in the scintillators.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2022-185711, filed Nov. 21, 2022, No. 2023-027291, filed Feb. 24, 2023, and No. 2023-132093, filed Aug. 14, 2023, which are hereby incorporated by reference herein in their entirety.

What is claimed is:

1. A radiation imaging apparatus comprising:
a radiation detection unit including a scintillator for converting radiation into light and a photoelectric conversion element for converting light into electric charge and configured to generate an image;
an acquisition unit configured to acquire a first image generated by the radiation detection unit in a radiation irradiated state and, after that, acquire a second image generated by the radiation detection unit in a radiation non-irradiated state; and
an estimation unit configured to estimate presence or absence of bright burn in the scintillator based on the second image.

2. The radiation imaging apparatus according to claim 1, wherein a resetting operation for the radiation detection unit is not performed between acquisition of the first image and acquisition of the second image and is performed after acquisition of the second image.

3. The radiation imaging apparatus according to claim 1, wherein, in a case where a difference between pixel values in the second image is greater than or equal to a threshold value, the estimation unit estimates that bright burn in the scintillator is present, and, in a case where a difference between pixel values in the second image is neither greater than nor equal to the threshold value, the estimation unit estimates that bright burn in the scintillator is absent.

4. The radiation imaging apparatus according to claim 1, wherein an operation condition for generation of the second image of the radiation detection unit is identical with an operation condition for generation of the first image of the radiation detection unit.

5. The radiation imaging apparatus according to claim 1, wherein a frame rate for generation of the second image of the radiation detection unit is faster than a frame rate for generation of the first image of the radiation detection unit.

6. The radiation imaging apparatus according to claim 1, wherein the estimation unit estimates the presence or absence of bright burn in the scintillator based on an image obtained by performing image processing on the second image.

7. The radiation imaging apparatus according to claim 1, further comprising a notification unit configured to issue a notification in a case where it is estimated by the estimation unit that bright burn in the scintillator is present.

8. The radiation imaging apparatus according to claim 1, wherein the first image is an image for a plurality of frames.

9. The radiation imaging apparatus according to claim 1,
wherein each of the first image and the second image is an image for one frame,
wherein the acquisition unit repeats acquisition of a frame of the first image and acquisition of a frame of the second image a plurality of times, and
wherein the estimation unit estimates the presence or absence of bright burn in the scintillator based on a last frame of the second image.

10. A radiation imaging apparatus comprising:
an acquisition unit configured to acquire a radiation image captured by a detection unit for detecting incident radiation and gain correction data; and
a gain correction unit configured to correct the radiation image using the gain correction data,
wherein, in a case where bright burn occurs in the detection unit, the gain correction unit corrects the radiation image using the gain correction data acquired by performing gain calibration after occurrence of bright burn.

11. The radiation imaging apparatus according to claim 10, further comprising:
a switching unit configured to switch the gain correction data to be used for correction by the gain correction unit; and
a storage unit configured to store first gain correction data acquired when bright burn is not occurring,
wherein the switching unit switches the gain correction data to be used to the first gain correction data stored in the storage unit in response to at least one of an elapsed time since occurrence of bright burn and a number of times of image capturing performed since occurrence of bright burn.

12. The radiation imaging apparatus according to claim 11, wherein, in a case where a predetermined time has elapsed after the gain correction data is acquired after occurrence of bright burn, the switching unit switches the gain correction data to be used to the first gain correction data.

13. The radiation imaging apparatus according to claim 11, wherein, in a case where a predetermined time has elapsed after bright burn occurs, the switching unit switches the gain correction data to be used to the first gain correction data.

14. The radiation imaging apparatus according to claim 10, wherein, after occurrence of bright burn, the gain correction unit corrects the radiation image using the gain correction data obtained by adjusting, based on an amount of attenuation of bright burn, the gain correction data acquired by performing gain calibration after occurrence of bright burn.

15. A radiation imaging system comprising:
the radiation imaging apparatus according to claim 1; and
a radiation source configured to radiate radiation.

16. A radiation imaging system comprising:
the radiation imaging apparatus according to claim 10; and
a radiation source configured to radiate radiation.

17. A control method for a radiation imaging apparatus including a radiation detection unit including a scintillator for converting radiation into light and a photoelectric conversion element for converting light into electric charge and configured to generate an image, the control method comprising:
acquiring a first image generated by the radiation detection unit in a radiation irradiated state and, after that, acquiring a second image generated by the radiation detection unit in a radiation non-irradiated state; and
estimating presence or absence of bright burn in the scintillator based on the second image.

18. A control method for a radiation imaging apparatus including a detection unit for detecting incident radiation, the control method comprising:
acquiring a radiation image captured by the detection unit and gain correction data;
correcting the radiation image using the gain correction data; and
in a case where bright burn occurs in the detection unit, correcting the radiation image using the gain correction data acquired by performing gain calibration after occurrence of bright burn.

19. A non-transitory computer-readable storage medium storing a program for causing a computer to execute the control method according to claim 17.

20. A non-transitory computer-readable storage medium storing a program for causing a computer to execute the control method according to claim 18.
